(19) United States
(12) Patent Application Publication
(10) Pub. No.: US 2006/0037039 A1
(43) Pub. Date: Feb. 16, 2006

(54) Delivering data to radio or television during commercials

(75) Inventor: Janne Aaltonen, Turku (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/917,700

(22) Filed: Aug. 13, 2004

(51) Int. Cl. H04N 7/16; H04N 7/025; H04N 7/10

(52) U.S. Cl. 725/23; 725/34; 725/35

(57) ABSTRACT

A method of broadcasting and processing advertisement supported content is provided. Content, such as audio, video or audiovisual data is segmented into discrete units. The content is broadcasted to a plurality of mobile terminals with advertisements separating the discrete units of content. Bonus information that includes or indicates how to obtain bonus data is also provided to users of the mobile terminals as an incentive to persuade the users to observe the advertisements.

### FIELD OF THE INVENTION

Aspects of the present invention relate to the transmission of content for viewing and/or listening by end users. More specifically, aspects of the present invention provide systems and methods that encourage users to view and/or listen to commercial content.

### BACKGROUND

Commercial television and radio broadcasters typically use advertisements to pay for the development and delivery of content. It is common, for example, for over-the-air, cable and satellite broadcasters to divide a program into several discrete segments and broadcast advertisements in between the discrete segments of the program.

It is common for users to attempt to avoid observing advertisements when watching or listening to a program. Users often change the channel or concentrate on other tasks during the commercials. The development of digital video recorders has made it very easy for users to observe the broadcasted content while avoiding advertisements. Several hours of programming can be recorded with digital video recorder. And, during playback, the user can fast forward past or skip over the advertisements.

Therefore, there is a need in the art for systems and methods that provide incentives to users to observer advertisements that are broadcasted along with advertisement supported content. Without such incentives, it will become even more likely that users will not observe the advertisements. This leads to advertisers becoming unwilling to purchase advertisements or becoming more likely to devote fewer resources to purchase advertisements. Without such advertisements, the business model of using advertisements to finance the development and delivery of content is put at risk.

### BRIEF SUMMARY

Aspects of the present invention address one or more of the issues mentioned above, thereby providing systems and methods that provide incentives to users to observe advertisements that are broadcasted during the broadcasting of a program.

In a first embodiment, a method of broadcasting advertisement supported content is provided. The method includes segmenting the content into discrete units and broadcasting the content and advertisements with at least some advertisements separating the discrete units of content. Bonus information that encourages users to observe the advertisements is also broadcasted.

In another embodiment of the invention, a mobile terminal that processes advertisement supported content is provided. The mobile terminal includes a receiver that receives a data stream of discrete units of content separated by advertisements. An ordering information module stores bonus data ordering information that is broadcasted along with the advertisements. A messaging module creates a message from the ordering information for ordering the bonus data.

In yet another embodiment of the invention, a mobile terminal that processes advertisement supported content is provided. The mobile terminal includes a receiver that receives a data stream of discrete units of content separated by advertisements and a bonus data memory module that stores bonus data that is broadcasted along with one or more of the advertisements.

One or more of the disclosed methods may be wholly or partially recorded as computer executable instructions on a computer readable medium, such as an optical disk, magnetic disk or physical memory.

### BRIEF DESCRIPTION OF THE DRAWINGS

Aspects of the present invention are described with respect to the accompanying figures, in which like reference numerals identify like elements, and in which:

FIG. 1 shows a configuration in which a mobile terminal receives advertisement supported content and bonus information, in accordance with an embodiment of the invention;

FIG. 2 shows a method of broadcasting advertisement supported content and bonus information in accordance with an embodiment of the invention; and

FIG. 3 shows a configuration in which a mobile terminal provides profile information that is used to select bonus data, in accordance with an embodiment of the invention.

### DETAILED DESCRIPTION

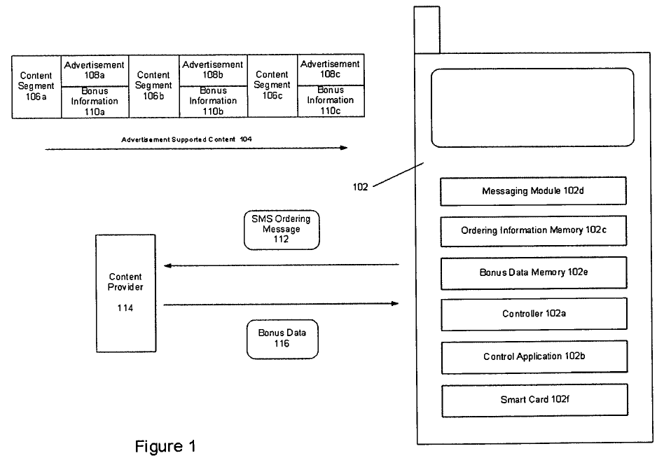

FIG. 1 shows a configuration in which a mobile terminal 102 receives advertisement supported content stream 104, in accordance with an embodiment of the invention. Advertisement supported content stream 104 includes a plurality of discrete content segments 106a, 106b and 106c. Discrete content segments 106a, 106b and 106c may include audio, visual or audiovisual content. Advertisements 108a, 108b and 108c separate discrete content segments. Bonus information 110a, 110b and 110c is broadcasted along with advertisements 108a, 108b and 108c. The use of bonus information is described in detail below.

Advertisement supported content stream 104 may be broadcasted or transmitted by a television station, radio station, Internet website or any other entity that broadcasts or transmits content and advertisements to users. In one embodiment, data is broadcasted or transmitted using an Internet protocol datacasting service. In another embodiment, data is broadcasted or transmitted using digital video broadcast (DVB, ATSC, ISDB and their different versions including broadcasts for mobile and handheld terminals) transmissions.

As shown, a terminal 102 may include an antenna 118 for transmitting signals to and for receiving signals from a base site or base station (BS). The base station may be a part of a cellular network that includes elements required to operate the network, such as a mobile switching center (MSC). As well known to those skilled in the art, the cellular network may also be referred to as a Base Station/MSC/Interworking function (BMI). In operation, the MSC is capable of routing calls and messages to and from the terminal when the terminal is making and receiving calls. The MSC also provides a connection to landline trunks when the terminal is involved in a call. Further, the MSC can be coupled to a server gateway (GTW).

The MSC can be coupled to a data network, such as a local area network (LAN), a metropolitan area network (MAN), and/or a wide area network (WAN). The MSC can be directly coupled to the data network. In one typical embodiment, however, the MSC is coupled to a GTW, and the GTW is coupled to a WAN, such as the Internet. In turn, devices such as processing elements (e.g., personal computers, server computers or the like) can be coupled to terminal 102 via the Internet.

In addition to the MSC, the BS can be coupled to a signaling GPRS (General Packet Radio Service) support node (SGSN). As known to those skilled in the art, the SGSN is typically capable of performing functions similar to the MSC for packet switched services. The SGSN, like the MSC, can be coupled to a data network, such as the Internet. The SGSN can be directly coupled to the data network. In a more typical embodiment, however, the SGSN is coupled to a packet-switched core network, such as a GPRS core network. The packet-switched core network is then coupled to another GTW, such as a GTW GPRS support node (GGSN), and the GGSN is coupled to the Internet. In addition to the GGSN, the packet-switched core network can also be coupled to a GTW.

By coupling the SGSN to the GPRS core network and the GGSN, devices such as origin servers can be coupled to terminal 102 via the Internet, SGSN and GGSN. In this regard, devices such as origin servers can communicate with the terminal across the SGSN, GPRS and GGSN. For example, origin servers can provide content to the terminal, such as in accordance with the Multimedia Broadcast Multicast Service (MBMS). For more information on the MBMS, see Third Generation Partnership Project (3GPP) technical specification 3GPP TS 22.146, entitled: Multimedia Broadcast Multicast Service (MBMS), the contents of which are hereby incorporated by reference in its entirety.

In addition to being coupled to the BS, terminal 102 can be wirelessly coupled to one or more wireless access points (APs). The APs can comprise access points configured to communicate in accordance techniques such as, for example, radio frequency (RF), Bluetooth (BT), infrared (IrDA) or any of a number of different wireless networking techniques, including WLAN techniques. Additionally, or alternatively, terminal 102 can be coupled to one or more user processors. Each user processor can comprise a computing system such as personal computers, laptop computers or the like. In this regard, the user processors can be configured to communicate with the terminal in accordance with techniques such as, for example, RF, BT, IrDA or any of a number of different wireline or wireless communication techniques, including Universal Serial Bus (USB), LAN and/or WLAN techniques. One or more of the user processors can additionally, or alternatively, include a removable memory capable of storing content, which can thereafter be transferred to the terminal.

Terminal 102 can further be coupled to one or more portable electronic devices, such as digital cameras and/or other multimedia capturing, producing and/or storing devices. Like with the user processors, the terminal can be configured to communicate with the portable electronic devices in accordance with techniques such as, for example, RF, BT, IrDA or any of a number of different wireline or wireless communication techniques, including USB, LAN and/or WLAN techniques.

The APs and user processors may be coupled to the Internet. Like with the MSC, the APs and user processors can be directly coupled to the Internet. In one embodiment, however, the APs are indirectly coupled to the Internet via a GTW. As will be appreciated, by directly or indirectly connecting the terminals and the origin server, as well as any of a number of other devices, to the Internet, the terminals, as well as portable electronic devices coupled to such terminals, can communicate with one another, the origin server, etc., to thereby carry out various functions of the terminal (and portable electronic devices), such as to transmit data, content or the like to, and/or receive content, data or the like from, the origin server. As used herein, the terms “data,” “content,” “information” and similar terms may be used to interchangeably to refer to data capable of being transmitted, received and/or stored in accordance with embodiments of the present invention. Thus, use of any such terms should not be taken to limit the spirit and scope of the present invention.

Further, terminal 102 can additionally, or alternatively, be coupled to a digital broadcaster via a digital broadcast network, such as a terrestrial digital video broadcasting (e.g., DVB-T, DVB-H, ISDB-T, ATSC, etc.) network. As will be appreciated, by directly or indirectly connecting the terminals and the digital broadcaster, the terminals can receive content, such as content for one or more television, radio and/or data channels, from the digital broadcaster. In this regard, the digital broadcaster can include, or be coupled to, a transmitter (TX), such as a DVB-T TX. Similarly, the terminal can include a receiver, such as a DVB-T receiver. The terminal can be capable of receiving content from any of a number of different entities in any one or more of a different number of manners. In one embodiment, for example, the terminal can comprise a terminal capable of transmitting and/or receiving data, content or the like in accordance with a DVB (e.g., DVB-T, DVB-H, etc.) technique as well as a cellular (e.g., 1G, 2G, 2.5G, 3G, etc.) communication technique. In such an embodiment, terminal 102 may include an antenna for receiving content from the DVB-T TX, and another antenna for transmitting signals to and for receiving signals from a BS. For more information on such a terminal, see U.S. patent application Ser. No. 09/894,532, entitled: Receiver, filed Jun. 29, 2001, the contents of which is incorporated herein by reference in its entirety.

In addition to, or in lieu of, directly coupling terminal 102 to the digital broadcaster via the TX, the terminal can be coupled to a digital broadcast (DB) receiver which, in turn, can be coupled to the digital broadcaster, such as directly and/or via the TX. In such instances, the digital broadcast receiver can comprise a DVB-T receiver, such as a DVB-T receiver in the form of a set top box. The terminal can be locally coupled to the digital broadcast receiver, such as via a personal area network. In one embodiment, however, the terminal can additionally or alternatively be indirectly coupled to the digital broadcast receiver via the Internet.

Mobile terminal 102 may be implemented with a mobile telephone, personal digital assistant, computer device or similar device capable of receiving and processing advertisement supported content stream 104. Mobile terminal 102 may include a controller 102a and control application 102b for controlling the overall operation of mobile terminal 102. An ordering information memory module 102c may be included to store ordering information that may be used to order bonus data. In one embodiment of the invention, bonus information 110a, 110b and/or 110c may include ordering information. Mobile terminal 102 may also include a bonus data memory module for storing bonus data. Mobile terminal 102 may comprise necessary components and (sub)assemblies for providing two-way communications capabilities such as a mobile phone and digital video broadcast receiving capabilities, wherein at least some of the components and (sub)assemblies may be common for these functions.

A messaging module 102d may be included to transmit ordering messages, such as SMS ordering messages 112 to one or more content providers, such as content provider 114. In addition to SMS, messages may be sent using WAP, WEB, BT and other message formats and systems. In one embodiment of the invention, messaging module 102d uses ordering information stored in ordering information memory module 102c and user and/or terminal identification and preference data taken from a smart card 102f to compose an appropriate message. The user and/or terminal identification and preference data may be stored instead of or in addition to the smart card in other data storage locations or devices within or connected to the mobile terminal such as e.g. in flash memories or other detachable memory devices. Content provider 114 may use received messages for customer tracking purposes.

In one embodiment of the invention, after receiving an ordering message, content provider 114, transmits bonus data 116 to mobile terminal 102. Bonus data my be in the form of a ringing tone, an operator logo, an encryption key, an application, a game programmed in Java, symbian, C++ or another programming language, a symbian application or any other data that may be transmitted to a mobile terminal or other receiver. In one embodiment, the bonus data comprises a password that may be used to access a subsequent content segment. In another embodiment, the bonus data may be a ringing tone or screen saver that is related to or extracted from the content. Examples of such bonus data are ringing tones corresponding to a theme of the movie or images or video clips from the movie. Further in some embodiments the bonus data may be a discount coupon or the received ringing tone, operator logo or screensaver may be used as a discount coupon.

According to one embodiment of the present invention bonus data can be used as a partial payment for a subscription of content. According to this embodiment a user subscribes to content and receives a discount on the price of the subscription for viewing advertisments. In this embodiment there is no need to actually transfer any bonus data to a terminal hence it can be controlled and stored in a server.

Bonus data may also be broadcasted to a mobile terminal during broadcasting of a plurality of advertisements. The received segments of bonus data may be stored and combined in a mobile terminal. The user may receive a notification after the last segment of bonus data arrives at the mobile terminal. In embodiments that broadcast a plurality of segments of bonus data, the user may be given a short period of time to send a message or take some other action to confirm that the user observed the corresponding advertisement and that the user is interested in accessing the bonus data. For example, a screensaver may be divided into four bonus data segments and each segment may be broadcasted along with four different advertisements. After each segment is broadcasted, users may be given a period of time, e.g. one minute, to send an SMS message to an address to store that segment in the bonus data memory. In still another embodiment, a user may be prompted after each bonus segment is received and asked to accept the segment to be stored in the bonus data memory. The acceptance may be required to take place within a predetermined time period. In one embodiment of the invention the bonus data segments are combined into a complete bonus data file, when the last received segment is accepted by the user. In another embodiment of the invention the bonus data can be consumed immediately after accepting the last segment. In yet another embodiment of the invention the user is prompted when all or some of the previous segments have not been accepted and may be prevented from sending an order or as a response to the order the user is notified on the deficits.

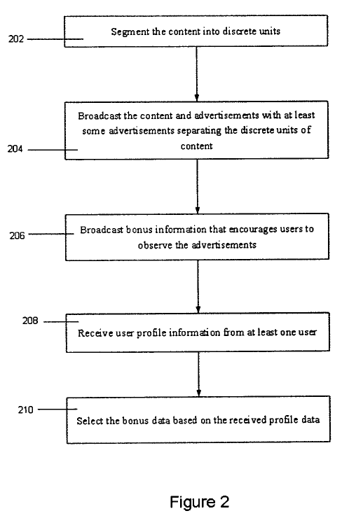

FIG. 2 shows a method of broadcasting advertisement supported content and bonus information in accordance with an embodiment of the invention. First, in step 202, content is segmented into discrete units. In step 204, the content and advertisements are broadcasted with at least some of the advertisements separating the discrete units of content. Bonus information that encourages users to observe advertisements is broadcasted in step 206.

The broadcasting of bonus information may occur during the broadcasting of advertisements. In alternative embodiments, bonus information is broadcasted at other times and activation or authorization information may be broadcasted or presented to users during or shortly after advertisements are presented to users. In some embodiments of the invention, bonus information includes information that allows a user to order or activate bonus data. In other embodiments, bonus information may include bonus data or parts of it.

The type of bonus data made available to users may be determined by users. In step 208 user profile data may be received from at least one user and then in step 210, the bonus data may be selected based on the received profile data. In some embodiments of the invention instead of or in addition to the user profile data, terminal profile or preference data may also be received and the selection of the bonus data or its format is based on the combination of the user and terminal profile data.

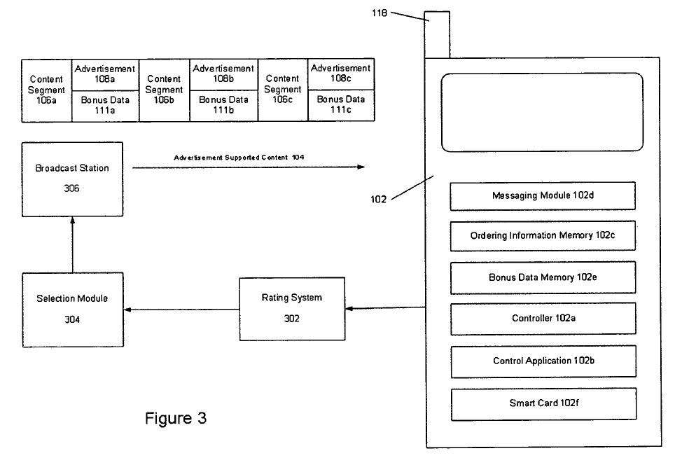

FIG. 3 shows a configuration in which a mobile terminal provides profile information that is used to select bonus data, in accordance with an embodiment of the invention. The embodiment shown in FIG. 3 is similar to the embodiment shown in FIG. 1. Like elements have been labeled the same. In the embodiment shown in FIG. 3, bonus data 111a, 111b and 111c are broadcasted as part of advertisement supported content stream 104. That is, bonus information 110a, 110b and 110c (shown in FIG. 2) has been implemented with bonus data 111a, 111b and 111c. Two or more of bonus data 111a, 111b and 111c may be segments of a larger segment of bonus data.

In the embodiment shown in FIG. 3, mobile terminal 102 may provide information to a rating system 302. The information may be in the form of profile information retrieved or derived from information stored on smart card 102f. Rating system 302 may alternatively receive requests or answers to questions from users of mobile terminals. Ratings system 302 may then compile the received information and transmit compiled information to a selection module 304. Selection module 304 may then select bonus information based on the compiled information. The selected bonus information or an identification of bonus information may then be provided to a broadcast station 306. Broadcast station 306 may then insert the selected bonus information into advertisement supported content stream 104. The embodiment shown in FIG. 3 ensures that the bonus information provided to users is the type of information wanted by at least several of the users.

According to one embodiment of the present invention, statistics relating to observing of advertisements and/or use of bonus information is stored and/or transferred to a server. For example, a terminal may store information indicating which advertisements were observed and which bonus data was utilized. The stored data may then be sent to a server or other source of advertisements and/or bonus data. Data correlating the observation of advertisements and usage of bonus data may be used when selecting bonus data. The obtained data may also be used to evaluate advertisements.

The present invention has been described in terms of preferred and exemplary embodiments thereof. Numerous other embodiments, modifications and variations within the scope and spirit of the appended claims will occur to persons of ordinary skill in the art from a review of this disclosure. For example, a receiver in the form of a digital set-top box may be used in place of the disclosed mobile terminals.

We claim:

1. A method of transferringadvertisement supported content, the method comprising:
(a) segmenting the content into discrete units; and
(b) transferring the content and advertisements with at least some advertisements separating the discrete units of content; and
(c) transferring along with the advertisements bonus information that encourages users to observe the advertisements.

2. The method of claim 1, wherein the bonus information comprises ordering information for ordering bonus data.

3. The method of claim 2, wherein the ordering information includes a time period for ordering the bonus data.

4. The method of claim 1, wherein the bonus information comprises bonus data.

5. The method of claim 4, wherein the bonus data comprises a ring tone.

6. The method of claim 4, wherein the bonus data comprises an operator logo.

7. The method of claim 4, wherein the bonus data comprises an encryption key.

8. The method of claim 4, wherein the bonus data comprises a password.

9. The method of claim 8, wherein the password allows a user to observe at least one of the discrete units of content.

10. The method of claim 4, wherein the bonus data comprises an application.

11. The method of claim 1, wherein (b) comprises broadcasting radio data.

12. The method of claim 1, wherein (b) comprises broadcasting television data.

13. The method of claim 1, further including:
(d) receiving user profile information from at least one user; and
(e) selecting the bonus data based on the received profile data.

14. The method of claim 1, wherein the bonus information comprises bonus data that is partitioned and broadcasted during the broadcasting of a plurality of the advertisements.

15. The method of claim 2, wherein the ordering information includes an SMS address.

16. The method of claim 2, wherein the ordering information comprises information for sending a plurality of messages, each within a predetermined time period following the broadcasting of an advertisement.

17. The method of claim 1, further including storing bonus data at a receiver when receiving an acceptance command from a user.

18. The method of claim 17, wherein the receiver comprises a mobile terminal.

19. The method of claim 1, wherein (b) comprises multicasting the content and advertisements.

20. The method of claim 1, wherein (b) comprises transmitting the content and advertisements via the Internet.

21. A mobile terminal that is capable of processing advertisement supported content, the mobile terminal comprising:
a receiver capable of receiving a data stream of discrete units of content separated by advertisements;
an ordering information module capable of storing bonus data ordering information that is broadcasted along with the advertisements; and
a messaging module that capable of creating a message from the ordering information for ordering the bonus data.

22. The mobile terminal of claim 21, further including a bonus data memory module cable of storing the bonus data.

23. The mobile terminal of claim 22, wherein the bonus data is stored in the bonus data memory module before the message module creates the message for ordering the bonus data.

24. A mobile terminal capable of processing advertisement supported content, the mobile terminal comprising:
a receiver capable of receiving a data stream of discrete units of content separated by advertisements; and
a bonus data memory module that is capable of storing bonus data that is to be broadcasted along with one or more of the advertisements.

25. The mobile terminal of claim 24, wherein the bonus data comprises a ringing tone.

26. The mobile terminal of claim 24, wherein the bonus data comprises an operator logo.

27. The mobile terminal of claim 24, wherein the bonus data comprises an encryption key.

28. The mobile terminal of claim 24, wherein the bonus data comprises a password.

29. The mobile terminal of claim 28, wherein the password allows a user to observe one of the discrete units of content.

30. A computer-readable medium containing computer executable instructions for causing a computer device to perform the steps comprising:
(a) segmenting content into discrete units; and
(b) associating advertisements with bonus information that encourages users to observe the advertisements;
(c) generating a stream of information that includes the advertisements and bonus information separating at least some of the discrete units of content; and
(c) transferring the stream of information to at least one receiving device.

31. A content server comprising:
a memory module; and
a processor programmed to perform the steps of:
(a) segmenting content into discrete units; and
(b) associating advertisements with bonus information that encourages users to observe the advertisements; and
(c) generating a stream of information that includes the advertisements and bonus information separating at least some of the discrete units of content.

32. The content server of claim 1, further including a transmission module capable of transmitting the stream of information at least one receiving device.
